(19) United States
(12) Patent Application Publication
(10) Pub. No.: US 2026/0304403 A1
(43) Pub. Date: Oct. 1, 2026

(54) MANAGING LBCA CAPABILITIES

(71) Applicant: Nokia Technologies Oy, Espoo (FI)

(72) Inventors: Bent Henneberg Rysgaard, Aalborg (DK); Rafael Cauduro Dias de Paiva, Cambridge (GB); Tanumay Manna, Bangalore (IN); Kim Nielsen, Aalborg (DK)

(21) Appl. No.: 19/575,550

(22) Filed: Mar. 23, 2026

(30) Foreign Application Priority Data
Mar. 28, 2025 (IN) 202541030096

(51) Int. Cl. H04W 72/0453; H04W 72/51

(52) U.S. Cl. CPC H04W 72/0453; H04W 72/51

(57) ABSTRACT

An apparatus including: at least one processor; and at least one memory storing instructions that, when executed with the at least one processor, cause the apparatus to perform: sending capability information related to or concerning band combinations for carrier aggregation of the apparatus for at least one of transmission-to-reception switched operation or reception-to-reception switched operation; and receiving configuration information from a network for the carrier aggregation.

### TECHNICAL FIELD

The example and non-limiting embodiments relate generally to carrier aggregation and, more particularly, to carrier aggregation capabilities.

### BRIEF DESCRIPTION OF PRIOR DEVELOPMENTS

Carrier aggregation is generally known including dual mode and switched mode carrier aggregation.

### SUMMARY OF THE INVENTION

The following summary is merely intended to be an example. The summary is not intended to limit the scope of the claims.

In accordance with one aspect, an example apparatus is provided comprising: at least one processor; and at least one memory storing instructions that, when executed with the at least one processor, cause the apparatus to perform: sending capability information related to or concerning band combinations for carrier aggregation of the apparatus for at least one of transmission-to-reception switched operation or reception-to-reception switched operation; and receiving configuration information from a network for the carrier aggregation.

In accordance with another aspect, an example embodiment is provided with a method comprising: sending capability information related to or concerning band combinations for carrier aggregation of an apparatus for at least one of: transmission-to-reception switched operation or reception-to-reception switched operation; and receiving configuration information from a network for the carrier aggregation.

In accordance with another aspect, an example embodiment is provided with an apparatus comprising: means for sending capability information related to or concerning band combinations for carrier aggregation of the apparatus for at least one of: a transmission-to-reception switched operation or a reception-to-reception switched operation; and means for receiving configuration information from a network for the carrier aggregation.

In accordance with another aspect, an example embodiment is provided with a non-transitory computer readable medium comprising program instructions that, when executed by an apparatus, cause the apparatus to perform at least the following: sending capability information related to or concerning band combinations for carrier aggregation of the apparatus for at least one of: a transmission-to-reception switched operation or a reception-to-reception switched operation; and receiving configuration information from a network for the carrier aggregation.

In accordance with another aspect, an example embodiment is provided with an apparatus comprising: at least one processor; and at least one memory storing instructions that, when executed with the at least one processor, cause the apparatus to perform: receiving carrier aggregation capability information of a user equipment for at least one of transmission-to-reception switched operation or reception-to-reception switched operation; and transmitting configuration information for the carrier aggregation to the user equipment.

In accordance with another aspect, an example embodiment is provided with a method comprising: receiving carrier aggregation capability information of a user equipment for at least one of: a transmission-to-reception switched operation or a reception-to-reception switched operation; and transmitting configuration information for the carrier aggregation to the user equipment.

In accordance with another aspect, an example embodiment is provided with an apparatus comprising: means for receiving carrier aggregation capability information of a user equipment for at least one of: a transmission-to-reception switched operation or a reception-to-reception switched operation; and means for transmitting configuration information for the carrier aggregation to the user equipment.

In accordance with another aspect, an example embodiment is provided a non-transitory computer readable medium comprising program instructions that, when executed by an apparatus, cause the apparatus to perform at least the following: receiving carrier aggregation capability information of a user equipment for at least one of: a transmission-to-reception switched operation or a reception-to-reception switched operation; and transmitting configuration information for the carrier aggregation to the user equipment.

According to some aspects, there is provided the subject matter of the independent claims. Some further aspects are provided in subject matter of the dependent claims.

### BRIEF DESCRIPTION OF DRAWINGS

The foregoing aspects and other features are explained in the following description, taken in connection with the accompanying drawings, wherein:

FIG. 1 is a block diagram of one possible and non-limiting example system in which the example embodiments may be practiced;

FIG. 2 is a diagram illustrating an example of band use in near field, transition field and far field;

FIG. 3 is a diagram illustrating an example of a proposed solution that enables supplementary downlink band utilization;

FIG. 4 is a diagram illustrating examples of band combinations suited for low-low band carrier aggregation;

FIG. 5A is a diagram illustrating a problem with regard to low-band low-band carrier aggregation switched operation;

FIG. 5B is a diagram illustrating an example embodiment;

FIG. 6 is a diagram illustrating an example embodiment;

FIG. 7A is a diagram illustrating an example embodiment;

FIG. 7B is a diagram illustrating an example embodiment;

FIG. 8 illustrates an example of a possible configuration of a low band CA switched mode for a n5A-n29A band combination;

FIGS. 9A and 9B illustrates examples of two possible configurations for a n5A-n25A-n29A band combination;

FIG. 10 is a diagram illustrating example embodiments using inherency;

FIG. 11 is a diagram illustrating an example method;

FIG. 12 is a diagram illustrating an example method.

### DETAILED DESCRIPTION

The following abbreviations that may be found in the specification and/or the drawing figures are defined as follows:
3GPP third generation partnership project
5G fifth generation
5GC 5G core network
6G sixth generation
AMF access and mobility management function
CA carrier aggregation
CU central unit
DC dual connectivity
DCI downlink control information
DL downlink
DU distributed unit
eNB (or eNodeB) evolved Node B (e.g., an LTE base station)
EN-DC E-UTRA-NR dual connectivity
en-gNB or En-gNB node providing NR user plane and control plane protocol terminations towards the UE, and acting as secondary node in EN-DC
E-UTRA evolved universal terrestrial radio access, i.e., the LTE radio access technology
FDD frequency division duplex
gNB (or gNodeB) base station for 5G/NR, i.e., a node providing NR user plane and control plane protocol terminations towards the UE, and connected via the NG interface to the 5GC
HO handover
IE information element
I/F interface
LB low band
LB-LB low band-low band
LBCA low band carrier aggregation
LBCAsw low band carrier aggregation via switching
LTE long term evolution
MAC medium access control
MME mobility management entity
MR-DC multi-radio dual connectivity
ng or NG next generation
ng-eNB or NG-eNB next generation eNB
non-CA non-carrier aggregation
NR new radio
N/W or NW network
OEM original equipment manufacturer
PDCCH physical downlink control channel
PDCP packet data convergence protocol
PHY physical layer
PCell primary cell
RAN radio access network
Rel release
Rel 18 release 18
Rel 19 release 19
RF radio frequency
RLC radio link control
RRH remote radio head
RRC radio resource control
RU radio unit
Rx receiver or reception
RX-RX reception-reception or reception-to-reception
SCell secondary cell
SDAP service data adaptation protocol
SDL supplementary downlink
SGW serving gateway
SMF session management function
TS technical specification
TTI transmission time interval
Tx transmitter or transmission
TX-RX transmission-reception or transmission-to-reception
UE user equipment (e.g., a wireless, typically mobile device)
UL uplink
UPF user plane function
WID work item description

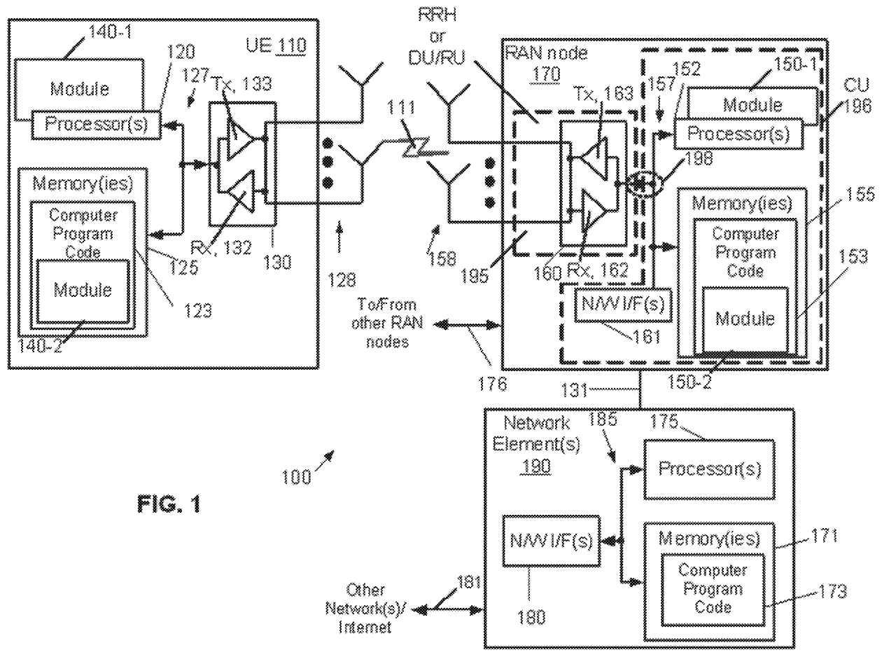

Turning to FIG. 1, this figure shows a block diagram of one possible and non-limiting example in which the examples may be practiced. A user equipment (UE) 110, radio access network (RAN) node 170, and network element(s) 190 are illustrated. The network element(s) 190 may include, for example, network equipment, network device(s), and one or more network entity, and might be understood to include, at least part of, a transmission reception point or a cell or a gNB or node for example. The term “network entity” generally refers to a function or functionality performed on a network. Network entities may be (co-) located at one or more of a network equipment such as a RAN node, a core network node, or a network server for example. In the example of FIG. 1, the user equipment (UE) 110 is in wireless communication with a wireless network 100. A UE is a wireless device that can access the wireless network 100. The UE 110 includes one or more processors 120, one or more memories 125, and one or more transceivers 130 interconnected through one or more buses 127. Each of the one or more transceivers 130 includes a receiver, Rx, 132 and a transmitter, Tx, 133. The one or more buses 127 may be address, data, or control buses, and may include any interconnection mechanism, such as a series of lines on a motherboard or integrated circuit, fiber optics or other optical communication equipment, and the like. The one or more transceivers 130 are connected to one or more antennas 128. The one or more memories 125 include computer program code 123. The UE 110 includes a module 140, comprising one of or both parts 140-1 and/or 140-2, which may be implemented in a number of ways. The module 140 may be implemented in hardware as module 140-1, such as being implemented as part of the one or more processors 120. The module 140-1 may be implemented also as an integrated circuit or through other hardware such as a programmable gate array. In another example, the module 140 may be implemented as module 140-2, which is implemented as computer program code 123 and is executed by the one or more processors 120. For instance, the one or more memories 125 and the computer program code 123 may be configured to, with the one or more processors 120, cause the user equipment 110 to perform one or more of the operations as described herein. The UE 110 communicates with RAN node 170 via a wireless link 111.

The RAN node 170 in this example is a base station that provides access by wireless devices such as the UE 110 to the wireless network 100. The RAN node 170 may be, for example, a base station for 5G, also called New Radio (NR). In 5G, the RAN node 170 may be a NG-RAN node, which is defined as either a gNB or a ng-eNB. A gNB is a node providing NR user plane and control plane protocol terminations towards the UE, and connected via the NG interface to a 5GC (such as, for example, the network element(s) 190). The ng-eNB is a node providing E-UTRA user plane and control plane protocol terminations towards the UE, and connected via the NG interface to the 5GC. The NG-RAN node may include multiple gNBs, which may also include a central unit (CU) (gNB-CU) 196 and distributed unit(s) (DUs) (gNB-DUs), of which DU 195 is shown. Note that the DU may include or be coupled to and control a radio unit (RU). The gNB-CU is a logical node hosting RRC, SDAP and PDCP protocols of the gNB or RRC and PDCP protocols of the en-gNB that controls the operation of one or more gNB-DUs. The gNB-CU terminates the F1 interface connected with the gNB-DU. The F1 interface is illustrated as reference 198, although reference 198 also illustrates a link between remote elements of the RAN node 170 and centralized elements of the RAN node 170, such as between the gNB-CU 196 and the gNB-DU 195. The gNB-DU is a logical node hosting RLC, MAC and PHY layers of the gNB or en-gNB, and its operation is partly controlled by gNB-CU. One gNB-CU supports one or multiple cells. One cell is supported by only one gNB-DU. The gNB-DU terminates the F1 interface 198 connected with the gNB-CU. Note that the DU 195 is considered to include the transceiver 160, e.g., as part of a RU, but some examples of this may have the transceiver 160 as part of a separate RU, e.g., under control of and connected to the DU 195. The RAN node 170 may also be an eNB (evolved NodeB) base station, for LTE (long term evolution), or any other suitable base station or node.

The RAN node 170 includes one or more processors 152, one or more memories 155, one or more network interfaces (N/W I/F(s)) 161, and one or more transceivers 160 interconnected through one or more buses 157. Each of the one or more transceivers 160 includes a receiver, Rx, 162 and a transmitter, Tx, 163. The one or more transceivers 160 are connected to one or more antennas 158. The one or more memories 155 include computer program code 153. The CU 196 may include the processor(s) 152, memories 155, and network interfaces 161. Note that the DU 195 may also contain its own memory/memories and processor(s), and/or other hardware, but these are not shown.

The RAN node 170 includes a module 150, comprising one of or both parts 150-1 and/or 150-2, which may be implemented in a number of ways. The module 150 may be implemented in hardware as module 150-1, such as being implemented as part of the one or more processors 152. The module 150-1 may be implemented also as an integrated circuit or through other hardware such as a programmable gate array. In another example, the module 150 may be implemented as module 150-2, which is implemented as computer program code 153 and is executed by the one or more processors 152. For instance, the one or more memories 155 and the computer program code 153 are configured to, with the one or more processors 152, cause the RAN node 170 to perform one or more of the operations as described herein. Note that the functionality of the module 150 may be distributed, such as being distributed between the DU 195 and the CU 196, or be implemented solely in the DU 195.

The one or more network interfaces 161 communicate over a network such as via the links 176 and 131. Two or more gNBs 170 may communicate using, e.g., link 176. The link 176 may be wired or wireless or both and may implement, for example, an Xn interface for 5G, an X2 interface for LTE, or other suitable interface for other standards.

The one or more buses 157 may be address, data, or control buses, and may include any interconnection mechanism, such as a series of lines on a motherboard or integrated circuit, fiber optics or other optical communication equipment, wireless channels, and the like. For example, the one or more transceivers 160 may be implemented as a remote radio head (RRH) 195 for LTE or a distributed unit (DU) 195 for gNB implementation for 5G, with the other elements of the RAN node 170 possibly being physically in a different location from the RRH/DU, and the one or more buses 157 could be implemented in part as, for example, fiber optic cable or other suitable network connection to connect the other elements (e.g., a central unit (CU), gNB-CU) of the RAN node 170 to the RRH/DU 195. Reference 198 also indicates those suitable network link(s).

It is noted that description herein indicates that “cells” perform functions, but it should be clear that equipment which forms the cell will perform the functions. The cell makes up part of a base station. That is, there can be multiple cells per base station. For example, there could be three cells for a single carrier frequency and associated bandwidth, each cell covering one-third of a 360 degree area so that the single base station's coverage area covers an approximate oval or circle. Furthermore, each cell can correspond to a single carrier and a base station may use multiple carriers. So if there are three 120 degree cells per carrier and two carriers, then the base station has a total of 6 cells.

The wireless network 100 may include a network element or elements 190 that may include core network functionality, and which provides connectivity via a link or links 181 with a further network, such as a telephone network and/or a data communications network (e.g., the Internet). Such core network functionality for 5G may include access and mobility management function(s) (AMF(S)) and/or user plane functions (UPF(s)) and/or session management function(s) (SMF(s)). Such core network functionality for LTE may include MME (Mobility Management Entity)/SGW (Serving Gateway) functionality. These are merely exemplary functions that may be supported by the network element(s) 190, and note that both 5G and LTE functions might be supported. The RAN node 170 is coupled via a link 131 to a network element 190. The link 131 may be implemented as, e.g., an NG interface for 5G, or an S1 interface for LTE, or other suitable interface for other standards. The network element 190 includes one or more processors 175, one or more memories 171, and one or more network interfaces (N/W I/F(s)) 180, interconnected through one or more buses 185. The one or more memories 171 include computer program code 173. The one or more memories 171 and the computer program code 173 are configured to, with the one or more processors 175, cause the network element 190 to perform one or more operations.

The wireless network 100 may implement network virtualization, which is the process of combining hardware and software network resources and network functionality into a single, software-based administrative entity, a virtual network. Network virtualization involves platform virtualization, often combined with resource virtualization. Network virtualization is categorized as either external, combining many networks, or parts of networks, into a virtual unit, or internal, providing network-like functionality to software containers on a single system. Note that the virtualized entities that result from the network virtualization are still implemented, at some level, using hardware such as processors 152 or 175 and memories 155 and 171, and also such virtualized entities create technical effects.

The computer readable memories 125, 155, and 171 may be of any type suitable to the local technical environment and may be implemented using any suitable data storage technology, such as semiconductor based memory devices, flash memory, magnetic memory devices and systems, optical memory devices and systems, fixed memory and removable memory. The computer readable memories 125, 155, and 171 may be means for performing storage functions. The processors 120, 152, and 175 may be of any type suitable to the local technical environment, and may include one or more of general purpose computers, special purpose computers, microprocessors, digital signal processors (DSPs) and processors based on a multi-core processor architecture, as non-limiting examples. The processors 120, 152, and 175 may be means for performing functions, such as controlling the UE 110, RAN node 170, and other functions as described herein.

In general, the various embodiments of the user equipment 110 can include, but are not limited to, cellular telephones such as smart phones, tablets, personal digital assistants (PDAs) having wireless communication capabilities, portable computers having wireless communication capabilities, image capture devices such as digital cameras having wireless communication capabilities, gaming devices having wireless communication capabilities, music storage and playback appliances having wireless communication capabilities, Internet appliances permitting wireless Internet access and browsing, tablets with wireless communication capabilities, as well as portable units or terminals that incorporate combinations of such functions.

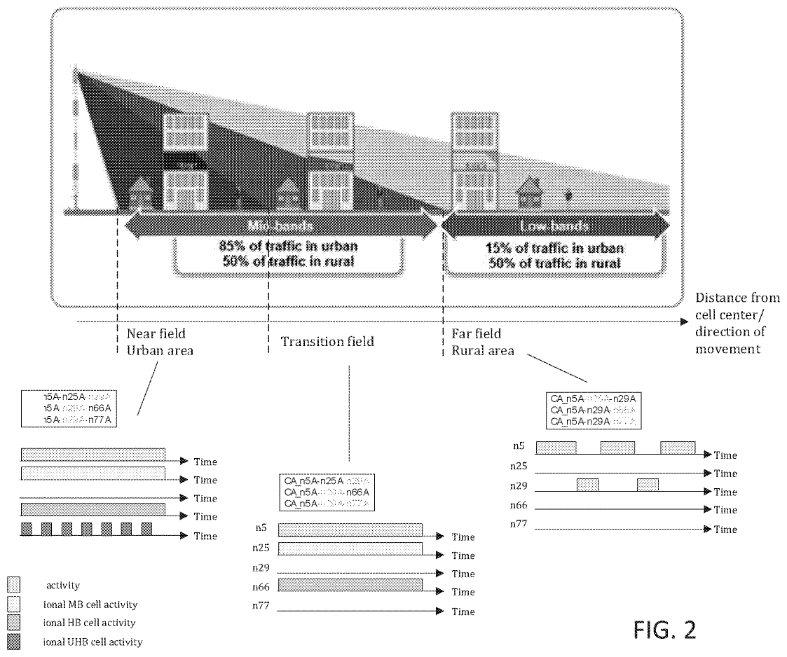

The amount of mid-band spectrum that an operator holds is usually about 10-20 times greater than the amount of low band spectrum. As shown in FIG. 2, the mid-band spectrum is useful closer to sites. However, the low-band spectrum propagates farther making it more useful further away from the sites. Low-band carries significant traffic volumes in urban (indoor) and rural areas causing low-band congestion that majorly degrades customer experience.

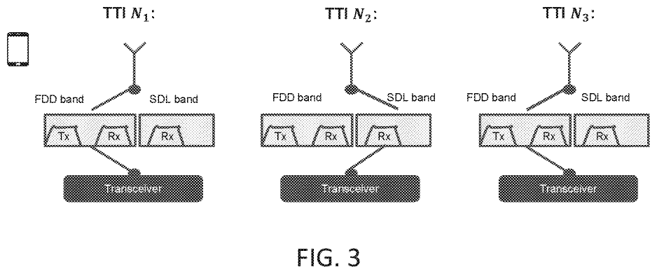

Low-Low band carrier aggregation (CA) would be one way to solve this problem, but such a solution does not exist as OEMs have challenges supporting it. Though low-band SDL (supplementary downlink) bands reach most of the poor coverage areas, the absence of a mid-band with an UL renders them useless. To this end, a solution may be that, as shown in FIG. 3, the UE switches configuration between two states of the RF front-end that are defined as Case 1 and Case 2 (an FDD-SDL LB-LB switched operation):
Case 1: 1 Tx/2 Rx on FDD carrier 1 and 0 Tx/0 Rx on SDL carrier 2
Case 2: 2 Rx on SDL carrier 2 and 0 Tx/0 on FDD carrier 1.

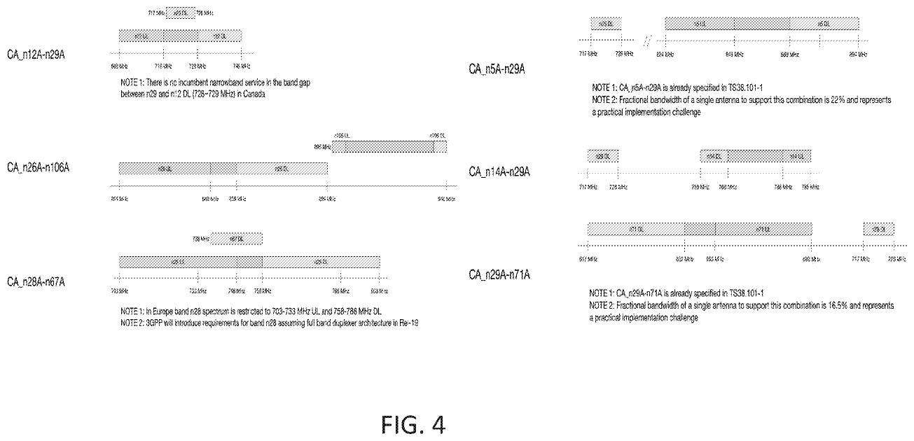

In this solution, the device needs to support inter-carrier scheduling: UE monitors FDD DL PDCCH DCI, which has both FDD and SDL scheduling, and the device switches back to FDD duplexer after SDL scheduled reception interval is finished. An example of the band combinations suited for low-low band CA are highlighted in FIG. 4. A low band is generally understood to be about 1 GHz or lower. The challenges in these combinations are not of an equal nature (hardware/software solution). For example, some aspects concern antenna design, while others are about duplex filters and gap sizes.

There are low-band, low-band band combinations currently specified in the specifications today that overlap with the band combinations which can also be switched. For example, an LBCA switching feature will work on band combinations such as CA-n5A-n29A which are already part of the traditional concurrent mode of operation. However, a UE may support such a band combination in either the normal way, in the switched way, or both in the normal way and in the switched way. So, there is a problem of how to indicate correctly the UE's support of modes of CA operation to the network. With features as described herein, the UE may indicate to the NW (such as through signaling or capability exchange for example) which particular mode of low band-low band CA operation the UE can support, and features may be used in regard to how the NW makes sense of that indication. Thus, features as described herein may be used to provide a backward compatibility issue of supporting LBCAsw compared to concurrent legacy CA.

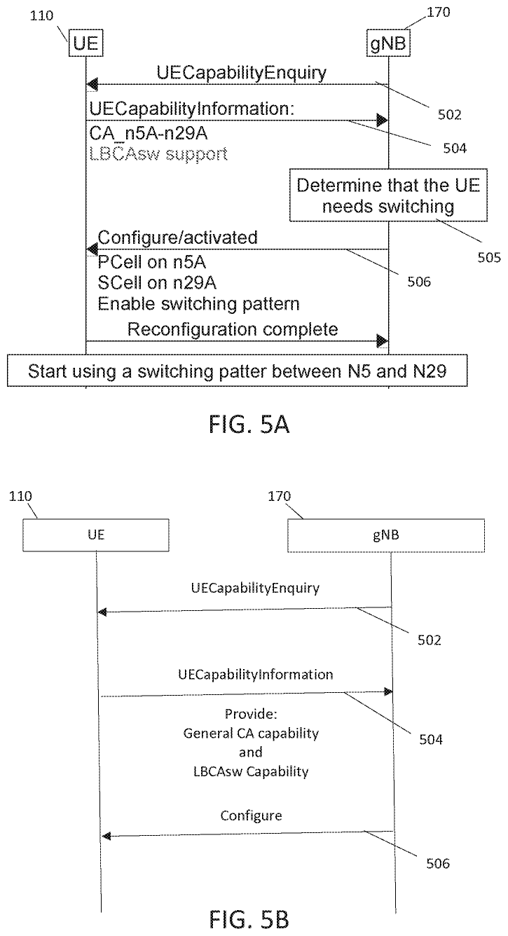

Features as described herein may be used to provide different possible UE capability information elements specifically for a band combination that can support both low band-low band CA switching mode (LBCAsw) of operation as well as the traditional concurrent mode of CA operation. Different alternative examples are described below. As seen with the example shown in FIG. 5A, the gNB 170 may request 502 the UE 110 to send information to the base station regarding the UE's CA capabilities. The UE 110 may send the message 504 to the gNB 170 indicating the UE's CA capabilities. In this example this comprises LBCAsw support for CA_n5A-n25A (a 2CA band combination). As indicated with 505, the gNB or NW may determine that the UE 110 needs switching and then sends the message 506 to the UE. In this example the message 506 indicates to the UE to enable a CA switching pattern with the n5A band for a PCell and the n29A band for an SCell. The UE may send a message to the gNB or network that the reconfiguration for the CA switching pattern is complete, and the UE may then start using the switching pattern between N5 and N29 bands.

Referring also to FIG. 5B an example of messages between the UE 110 and the base station or gNB 170 is shown. As indicated with 502, the gNB 170 may request the UE 110 to send information to the base station regarding the UE's CA capabilities. The UE 110 may send the message 504 to the gNB 170 indicating the UE's CA capabilities including the UE's general CA capability and the UE's LBCAsw capabilities. This may include, for example, uplink CA capabilities and downlink CA capabilities. For example, the information sent via message 504 may include BandCombinationList information, BandCombinationList-UplinkTxSwitch information, and BandCominationList-LBCAsw information. As seen with 506 in FIG. 5B, the gNB 170 may send configuration information to the UE 110 which may include configuration information for LBCAsw.

In an example, a LBCAsw capability list may be added, and only CA combinations inside a LBCAsw capability list (such as LBCAsw-r19 for example) support the switched mode operation. In this example, this CA combination is not declared in the general CA capability list, if the UE does not support the combination with concurrent operation without switching. Therefore, for this example it may be UE implementation specific which band combinations are defined in which list. Even for the FDD-SDL combinations, since they do not face the same challenge, CA_n5A-n29A may have difficulties in antenna bandwidth, while CA_n12A-n29A may have difficulties in using the duplex gap of the FDD band, so some UEs may place CA combinations in the list for switching due to antenna constraints, while other UEs may place CA combinations in the list as they cannot receive and transmit concurrently in the CA combined bands. LBCAsw may be used more broadly for other low band challenges such as CA_n5A-n8A, where uplink and downlink bands overlap in the frequency domain and therefore cannot operate concurrently. With this example, there may be provided both a general CA capability list and a LBCAsw capability list. With features as described herein, certain band combinations can occur in more than one of the band combination lists. So, if a band combination is supported in the original sense, the band combination can be specified in the general CA capability list, and if the same band combination can also be supported in a switched variant, then the band combination can also be specified in the switched list (the LBCAsw capability list). Of course, a device or user equipment which depends on switched operation may only specify the band combination in the switched capability list.

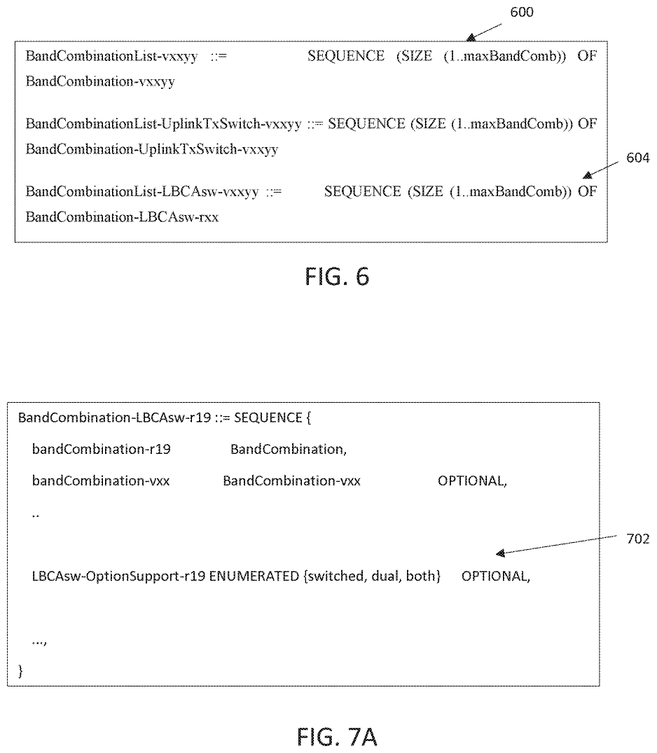

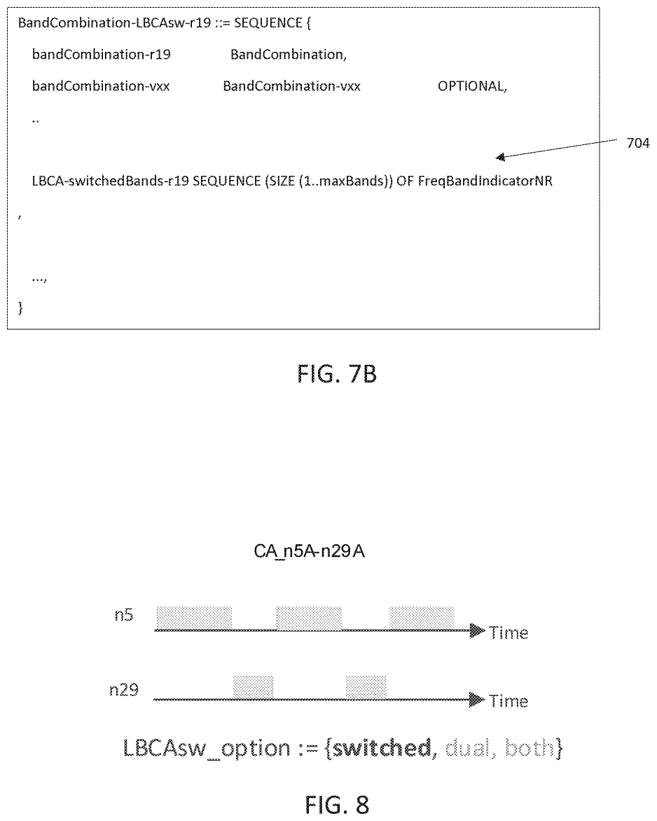

With this example, a separate list may be added for UE capabilities band combinations for LBCA switch mode. For example, as illustrated with FIG. 6, a BandCombinationList-LBCAsw information element 604 may be added to a UE capability IE 600. In an example, each band combination can have a set of attributes. In another example, all the band combinations within a list may share the same attributes. The attributes can enumerate whether the UE will support a ‘switched’ mode of low-band CA operation, or the traditional “dual” concurrent operation, or both the ‘switched’ or the ‘dual’ modes in a dynamic manner. This solution may provide the most flexibility in selecting the band combinations. This example is shown in FIG. 7A that comprises the field LBCAsw-OptionSupport-r19 702. The field is set by the UE according to its capability. The Network configures the UE after it receives UE's indication about its capability. In this example, there are three (3) possible selections or settings; “switched”, “dual”, and “both” for the field LBCAsw-OptionSupport-r19 702. However, in other examples, different types or numbers of settings may be provided. The field is set to “switched” if the UE supports the ‘switched’ mode of low-band CA operation. The field is set to “dual” if the UE supports simultaneous operation. The field is set to “both” if the UE supports both the ‘switched’ and the ‘dual’ modes and is able to use either mode dynamically. In an example, with the “both” setting, CA combination(s) can also be listed in the original BandCombinationList information element, not only in the BandCombinationList-LBCAsw information element.

Alternatively, or additionally, as shown in FIG. 7B, each band combination may comprise the field LBCA-switchedBands-r19 704. The field 704 may be used to specify which carriers need switching in case the band combination includes more than two carriers.

Referring also to FIG. 8, there is shown an example of a switched operation of n5A-n29A band combination that a UE may support by indicating ‘switched’ in the field LBCAsw-OptionSupport-r19 702.

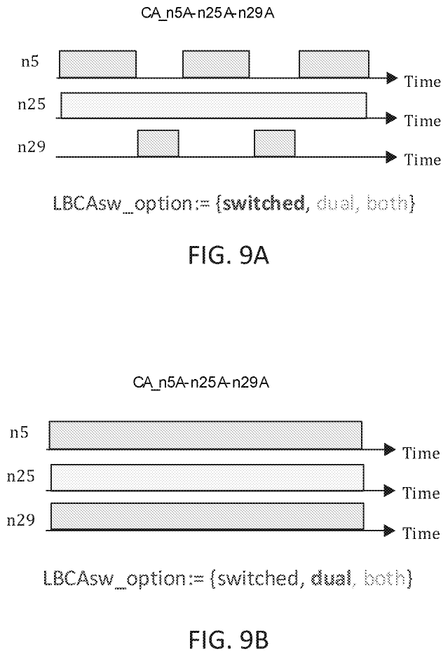

Referring also to FIGS. 9A and 9B, these figures illustrate examples of different operations of a n5A-n25A-n29A band combination where band n25A is always used. FIG. 9A illustrates a Low Band CA operation that the UE may support, where the LBCAsw_option has been set to “switched” and n5A and n29A bands can be configured with switched operation. FIG. 9B illustrates a Low Band CA operation that the UE may support, where the LBCAsw_option has been set to “dual” and, thus, the traditional or legacy CA mode can be configured. It is up to the UE capability which of the above can be configured to the UE by the network.

In an example, the attributes from a lower band combination can be inherited, and respected, by one or more higher band combinations when inheriting. In one type of example, any exception needs to be overwritten explicitly by attributes of a larger band combination. This has the advantage of a leaner UE band combination capability, thereby reducing the overhead.

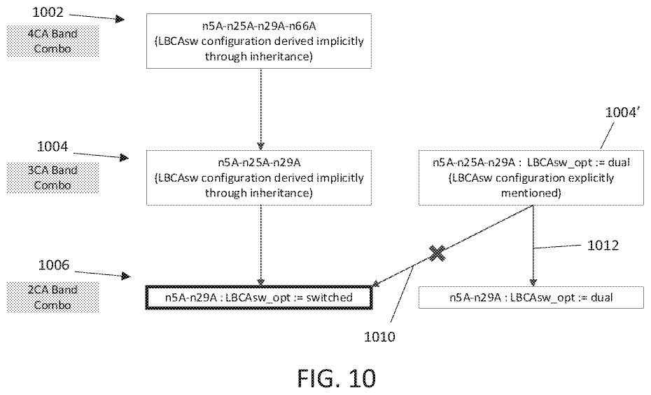

Referring also to FIG. 10, in this example the attributes from a lower band combination can be inherited and respected by higher band combos when inheriting. More specifically, as shown in FIG. 10, for the higher band combinations 1004 and 1002 of 3 CA and 4 CA, respectively, the network can determine the LBCAsw attribute via implicit inheritance from a lower band combination switching attribute. FIG. 10 shows three related band quantity or level combinations with a highest band combination 1002, a lowest band combination 1006, and one intermediate band combination 1004 between the highest and the lowest. In this example the highest band combination 1002 is a four CA band combination (4 CA Band Combo) having four bands n5A, n25A, n29A and n66A. In this example the intermediate band combination 1004 is a three-band combination (3CA Band Combo) having the three common bands n5A, n25A and n29A. In this example the lowest band combination 1006 is a two band combination (2CA Band Combo) having the two common bands n5A and n25A.

The network can configure the UE based on the network determining or using inheritance as a factor. With the example shown in FIG. 10, the network may use the switching attribute of the lowest band combo 1006 for the LBCAsw attribute of the intermediate band combo 1004; the network configuring for the band combo 1002 based on derived inheritance from the band combo 1004. Likewise, the network may use the switching attribute of the intermediate band combo 1004 for the LBCAsw attribute of the highest band combination 1002; the network configuring for the band combo 1002 based on derived inheritance from the band combo 1004.

There may, however, be exceptions. Any exception needs to be overwritten explicitly by larger band combination attributes. For example, if there is an explicit mention of a different attribute, then it may be used to override the base attribute, but perhaps only for that specific band combination. For example, as shown on the right side of FIG. 10, the 3 CA band combo has an LBCAsw attribute explicitly mentioned at 1004′. In this example the LBCAsw attribute explicitly mentioned is LBCAsw_opt: =dual and this explicitly overwrites the attribute for the band combo 1006. As shown by broken line 1010, the 3 CA band combo 1004′ does not inherit the attribute from 2 CA band combo 1006. Instead, the attribute of 2 CA band combo 1006 is changed from “switched” to “dual” as indicated by the arrow 1012.

An example embodiment may be provided with an apparatus comprising: at least one processor; and at least one memory storing instructions that, when executed with the at least one processor, cause the apparatus to perform: sending capability information related to or concerning carrier aggregation for at least one of TX-RX or Rx-RX switched operation. The instructions, when executed with the at least one processor, may cause the apparatus to perform receiving configuration information from a network for carrier aggregation.

An example embodiment may be provided with an apparatus comprising: at least one processor; and at least one memory storing instructions that, when executed with the at least one processor, cause the apparatus to perform: sending capability information related to or concerning band combinations for carrier aggregation of the apparatus for at least one of transmission-to-reception switched operation or reception-to-reception switched operation; and receiving configuration information from a network for the carrier aggregation.

The capability information of the apparatus may comprise information for band combinations for downlink switching. The capability information of the apparatus may comprise information for a low band carrier aggregation switched mode (LBCAsw). The capability information of the apparatus may comprise at least one of: an indication of a capability of the apparatus to support a low band carrier aggregation switched mode (LBCAsw) for a band combination, an indication of a capability of the apparatus to support a simultaneous mode of low band carrier aggregation (LBCA) for a band combination, or an indication of a capability of the apparatus to support both the low band carrier aggregation switched mode (LBCAsw) and the simultaneous mode of low band carrier aggregation (LBCA) for a band combination. The capability information may be separate from a capability information that is related to or concerning band combination that supports simultaneous mode of low band carrier aggregation (LBCA). The sending may comprise sending a BandCombinationList information element comprising: a capability of the apparatus to use one or more of a plurality of low band carrier aggregation switched mode options selected by a network. The capability of the apparatus to use one or more of a plurality of low band carrier aggregation switched mode options selected by a network may comprise a LBCAsw-OptionSupport-r19 field. The capability of the indication may comprise an indication of bands that need switching. The instructions, when executed with the at least one processor, may cause the apparatus to perform: providing, as part of the capability information, attributes for respective band combinations. The attributes may be configured to be used for determining whether the apparatus supports low band carrier aggregation switched mode (LBCAsw), or the simultaneous mode of low band carrier aggregation (LBCA), or low band carrier aggregation switched mode (LBCAsw) and the simultaneous mode of low band carrier aggregation (LBCA). The attributes of a first band combination may be inherited or overwritten by the attributes of a second band combination wherein the first band combination is a subset of the second band combination. The instructions, when executed with the at least one processor, may cause the apparatus to perform: configuring a low band carrier aggregation mode based on the received configuration information. The configuring may comprise the apparatus being configured for one of: a switched carrier aggregation mode, a dual carrier aggregation mode, or a selection mode for the apparatus to select the switched carrier aggregation more or the dual carrier aggregation mode. The configuring may comprise the apparatus being configured selecting carrier aggregation mode from a list of carrier aggregation modes. The configuring may comprise the apparatus being configured for bands which need switching in case a band combination includes two or more bands.

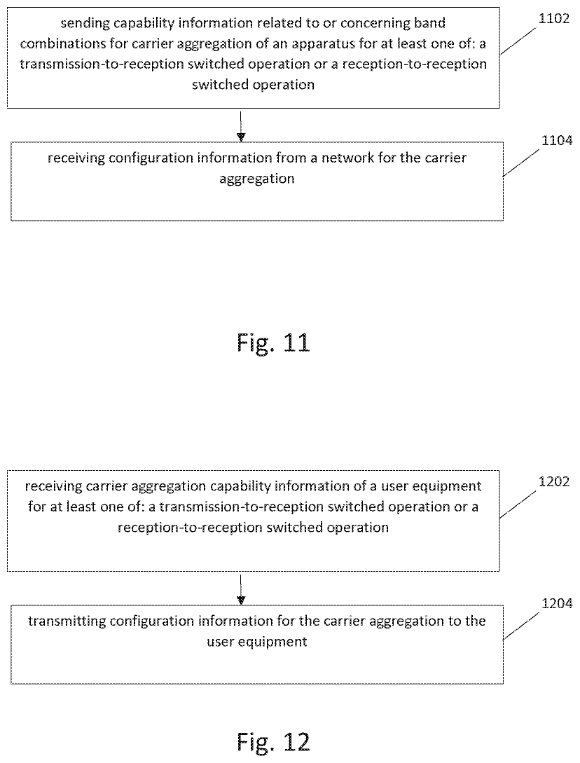

Referring also to FIG. 11, an example embodiment may be provided with a method comprising: sending capability information related to or concerning band combinations for carrier aggregation of an apparatus for at least one of: a transmission-to-reception switched operation or a reception-to-reception switched operation as indicated with block 1102; and receiving configuration information from a network for the carrier aggregation as indicated with block 1104. The capability information of the apparatus may comprise information for band combinations for downlink switching. The capability information of the apparatus may comprise information for a low band carrier aggregation switched mode (LBCAsw). The capability information of the apparatus may comprise at least one of: an indication of a capability of the apparatus to support a low band carrier aggregation switched mode (LBCAsw) for a band combination, an indication of a capability of the apparatus to support a simultaneous mode of low band carrier aggregation (LBCA) for a band combination, or an indication of a capability of the apparatus to support both the low band carrier aggregation switched mode (LBCAsw) and the simultaneous mode of low band carrier aggregation (LBCA) for a band combination. The capability information may be separate from a capability information that is related to or concerning band combination that supports simultaneous mode of low band carrier aggregation (LBCA). The sending may comprise sending a BandCombinationList information element comprising: a capability of the apparatus to use one or more of a plurality of low band carrier aggregation switched mode options selected by a network. The capability of the apparatus to use one or more of a plurality of low band carrier aggregation switched mode options selected by a network may comprise a LBCAsw-OptionSupport-r19 field. The capability of the indication may comprise an indication of bands that need switching. The method may comprise providing, as part of the capability information, attributes for respective band combinations. The attributes may be configured to be used for determining whether the apparatus supports low band carrier aggregation switched mode (LBCAsw), or the simultaneous mode of low band carrier aggregation (LBCA), or low band carrier aggregation switched mode (LBCAsw) and the simultaneous mode of low band carrier aggregation (LBCA). The attributes of a first band combination may be inherited or overwritten by the attributes of a second band combination wherein the first band combination is a subset of the second band combination. The method may comprise configuring a low band carrier aggregation mode based on the received configuration information. The configuring may comprise the apparatus being configured for one of: a switched carrier aggregation mode, a dual carrier aggregation mode, or a selection mode for the apparatus to select the switched carrier aggregation more or the dual carrier aggregation mode. The configuring may comprise the apparatus being configured selecting carrier aggregation mode from a list of carrier aggregation modes. The configuring may comprise the apparatus being configured for bands which need switching in case a band combination includes two or more bands.

An example embodiment may be provided with an apparatus comprising: means for sending capability information related to or concerning band combinations for carrier aggregation of the apparatus for at least one of: a transmission-to-reception switched operation or a reception-to-reception switched operation; and means for receiving configuration information from a network for the carrier aggregation.

An example embodiment may be provided with a non-transitory computer readable medium comprising program instructions that, when executed by an apparatus, cause the apparatus to perform at least the following: sending capability information related to or concerning band combinations for carrier aggregation of the apparatus for at least one of: a transmission-to-reception switched operation or a reception-to-reception switched operation; and receiving configuration information from a network for the carrier aggregation.

An example embodiment may be provided with an apparatus comprising: at least one processor; and at least one memory storing instructions that, when executed with the at least one processor, cause the apparatus to perform: receiving carrier aggregation capability information of a user equipment for at least one of transmission-to-reception switched operation or reception-to-reception switched operation; and transmitting configuration information for the carrier aggregation to the user equipment.

The capability information of the user equipment may comprise information for band combinations for downlink switching. The capability information of the user equipment may comprise information for a low band carrier aggregation switched mode (LBCAsw). The capability information of the user equipment may comprise at least one of: an indication of a capability of the user equipment to use a low band carrier aggregation switched mode (LBCAsw), an indication of a capability of the user equipment to use a simultaneous mode of low band carrier aggregation (LBCA), or an indication of a capability of the user equipment to use the low band carrier aggregation switched mode (LBCAsw) and the simultaneous mode of low band carrier aggregation (LBCA). The capability information may be separate from a capability information that is related to or concerning band combination that supports simultaneous mode of low band carrier aggregation (LBCA). The receiving may comprise receiving a BandCombinationList information element comprising: a capability of the user equipment to use one or more of a plurality of low band carrier aggregation switched mode options selected by the apparatus. The capability of the user equipment to use one or more of a plurality of low band carrier aggregation switched mode options selected by the apparatus may comprise a LBCAsw-OptionSupport-r19 field. The capability of the indication may comprise an indication of bands that need switching. The instructions, when executed with the at least one processor, may cause the apparatus to perform: receiving, as part of the capability information, attributes for respective band combinations. The attributes may be configured to be used for determining whether the user equipment supports low band carrier aggregation switched mode (LBCAsw), or the simultaneous mode of low band carrier aggregation (LBCA), or low band carrier aggregation switched mode (LBCAsw) and the simultaneous mode of low band carrier aggregation (LBCA). The attributes of a first band combination may be inherited or overwritten by the attributes of a second band combination wherein the first band combination is a subset of the second band combination.

Referring also to FIG. 12, an example embodiment may be provided with a method comprising: receiving carrier aggregation capability information of a user equipment for at least one of: a transmission-to-reception switched operation or a reception-to-reception switched operation as illustrated with block 1202; and transmitting, for the user equipment, configuration information for the carrier aggregation as illustrated with block 1204. The capability information of the user equipment may comprise information for band combinations for downlink switching. The capability information of the user equipment may comprise information for a low band carrier aggregation switched mode (LBCAsw). The capability information of the user equipment may comprise at least one of: an indication of a capability of the user equipment to use a low band carrier aggregation switched mode (LBCAsw), an indication of a capability of the user equipment to use a simultaneous mode of low band carrier aggregation (LBCA), or an indication of a capability of the user equipment to use the low band carrier aggregation switched mode (LBCAsw) and the simultaneous mode of low band carrier aggregation (LBCA). The capability information may be separate from a capability information that is related to or concerning band combination that supports simultaneous mode of low band carrier aggregation (LBCA). The receiving may comprise receiving a BandCombinationList information element comprising: a capability of the user equipment to use one or more of a plurality of low band carrier aggregation switched mode options selectable by the apparatus. The capability of the user equipment to use one or more of a plurality of low band carrier aggregation switched mode options selectable by the apparatus may comprise a LBCAsw-OptionSupport-r19 field. The capability of the indication may comprise an indication of bands that need switching. The method may comprise receiving, as part of the capability information, attributes for respective band combinations. The attributes may be configured to be used for determining whether the user equipment supports low band carrier aggregation switched mode (LBCAsw), or the simultaneous mode of low band carrier aggregation (LBCA), or low band carrier aggregation switched mode (LBCAsw) and the simultaneous mode of low band carrier aggregation (LBCA). The method may comprise the attributes of a first band combination being inherited or overwritten by the attributes of a second band combination wherein the first band combination is a subset of the second band combination.

An example embodiment may be provided with an apparatus comprising: means for receiving carrier aggregation capability information of a user equipment for at least one of: a transmission-to-reception switched operation or a reception-to-reception switched operation; and means for transmitting configuration information for the carrier aggregation to the user equipment.

An example embodiment may be provided with a non-transitory computer readable medium comprising program instructions that, when executed by an apparatus, cause the apparatus to perform at least the following: receiving carrier aggregation capability information of a user equipment for at least one of: a transmission-to-reception switched operation or a reception-to-reception switched operation; and transmitting configuration information for the carrier aggregation to the user equipment.

The term “non-transitory,” as used herein, is a limitation of the medium itself (i.e., tangible, not a signal) as opposed to a limitation on data storage persistency (e.g., RAM vs. ROM).

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory(ies) that work together to cause an apparatus, such as a mobile phone or server, to perform various functions) and
   (iii) hardware circuit(s) and or processor(s), such as a microprocessor(s) or a portion of a microprocessor(s), that requires software (e.g., firmware) for operation, but the software may not be present when it is not needed for operation.”

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

It should be understood that the foregoing description is only illustrative. Various alternatives and modifications can be devised by those skilled in the art. For example, features recited in the various dependent claims could be combined with each other in any suitable combination(s). In addition, features from different embodiments described above could be selectively combined into a new embodiment. Accordingly, the description is intended to embrace all such alternatives, modifications and variances which fall within the scope of the appended claims.

We claim:

1. An apparatus, comprising:
at least one processor; and
at least one memory storing instructions that, when executed with the at least one processor, cause the apparatus to perform:
sending capability information related to or concerning band combinations for carrier aggregation of the apparatus for at least one of transmission-to-reception switched operation or reception-to-reception switched operation; and
receiving configuration information from a network for the carrier aggregation.

2. The apparatus as claimed in claim 1, where the capability information of the apparatus comprises information for band combinations for downlink switching.

3. The apparatus as claimed in claim 1, where the capability information of the apparatus comprises information for a low band carrier aggregation switched mode (LBCA_{sw}).

4. The apparatus as claimed in claim 1, where the capability information of the apparatus comprises at least one of:
an indication of a capability of the apparatus to support a low band carrier aggregation switched mode (LBCA_{sw}) for a band combination,
an indication of a capability of the apparatus to support a simultaneous mode of low band carrier aggregation (LBCA) for a band combination, or
an indication of a capability of the apparatus to support both the low band carrier aggregation switched mode (LBCA_{sw}) and the simultaneous mode of low band carrier aggregation (LBCA) for a band combination.

5. The apparatus as claimed in claim 1, where the capability information is separate from a capability information that is related to or concerning band combination that supports simultaneous mode of low band carrier aggregation (LBCA).

6. The apparatus as claimed in claim 1, where the sending comprises sending a BandCombinationList information element comprising:
a capability of the apparatus to use one or more of a plurality of low band carrier aggregation switched mode options selected by a network.

7. The apparatus as claimed in claim 6, where the capability of the apparatus to use one or more of a plurality of low band carrier aggregation switched mode options selected by a network comprises a LBCAsw-OptionSupport-r19 field.

8. The apparatus as claimed in claim 1, where the capability of the indication comprises an indication of bands that need switching.

9. The apparatus as claimed in claim 1, where the instructions, when executed with the at least one processor, cause the apparatus to perform:
providing, as part of the capability information, attributes for respective band combinations.

10. The apparatus as claimed in claim 9, where the attributes are configured to be used for determining whether the apparatus supports low band carrier aggregation switched mode (LBCA_{sw}), or the simultaneous mode of low band carrier aggregation (LBCA), or low band carrier aggregation switched mode (LBCA_{sw}) and the simultaneous mode of low band carrier aggregation (LBCA).

11. The apparatus as claimed in claim 9, where the attributes of a first band combination is inherited or overwritten by the attributes of a second band combination wherein the first band combination is a subset of the second band combination.

12. The apparatus as claimed in claim 1, where the instructions, when executed with the at least one processor, cause the apparatus to perform:
configuring a low band carrier aggregation mode based on the received configuration information.

13. The apparatus as claimed in claim 12, where the configuring comprises the apparatus being configured for one of:
a switched carrier aggregation mode,
a dual carrier aggregation mode, or
a selection mode for the apparatus to select the switched carrier aggregation more or the dual carrier aggregation mode.

14. The apparatus as claimed in claim 13, where the configuring comprises the apparatus being configured selecting carrier aggregation mode from a list of carrier aggregation modes.

15. The apparatus as claimed in claim 12, where the configuring comprises the apparatus being configured for bands which need switching in case a band combination includes two or more bands.

16. A method, comprising:
sending capability information related to or concerning band combinations for carrier aggregation of an apparatus for at least one of: transmission-to-reception switched operation or reception-to-reception switched operation; and
receiving configuration information from a network for the carrier aggregation.

17. A non-transitory computer readable medium comprising program instructions that, when executed by an apparatus, cause the apparatus to perform:
sending capability information related to or concerning band combinations for carrier aggregation of the apparatus for at least one of: transmission-to-reception switched operation or reception-to-reception switched operation; and
receiving configuration information from a network for the carrier aggregation.

18. An apparatus, comprising:
at least one processor; and
at least one memory storing instructions that, when executed with the at least one processor, cause the apparatus to perform:
receiving carrier aggregation capability information of a user equipment for at least one of transmission-to-reception switched operation or reception-to-reception switched operation; and
transmitting configuration information for the carrier aggregation to the user equipment.

19. The apparatus as claimed in claim 18, where the capability information of the user equipment comprises information for band combinations for downlink switching.

20. The apparatus as claimed in claim 18, where the capability information of the user equipment comprises information for a low band carrier aggregation switched mode (LBCA_{sw}).

21. The apparatus as claimed in claim 18, where the capability information of the user equipment comprises at least one of:
an indication of a capability of the user equipment to use a low band carrier aggregation switched mode (LBCA_{sw}),
an indication of a capability of the user equipment to use a simultaneous mode of low band carrier aggregation (LBCA), or
an indication of a capability of the user equipment to use the low band carrier aggregation switched mode (LBCA_{sw}) and the simultaneous mode of low band carrier aggregation (LBCA).

22. The apparatus as claimed in claim 18, where the capability information is separate from a capability information that is related to or concerning band combination that supports simultaneous mode of low band carrier aggregation (LBCA).

23. The apparatus as claimed in claim 18, where the receiving comprises receiving a BandCombinationList information element comprising:
a capability of the user equipment to use one or more of a plurality of low band carrier aggregation switched mode options selected by the apparatus.

24. The apparatus as claimed in claim 23, where the capability of the user equipment to use one or more of a plurality of low band carrier aggregation switched mode options selected by the apparatus comprises a LBCAsw-OptionSupport-r19 field.

25. The apparatus as claimed in claim 18, where the capability of the indication comprises an indication of bands that need switching.

26. The apparatus as claimed in claim 18, where the instructions, when executed with the at least one processor, cause the apparatus to perform:
receiving, as part of the capability information, attributes for respective band combinations.

27. The apparatus as claimed in claim 26, where the attributes are configured to be used for determining whether the user equipment supports low band carrier aggregation switched mode (LBCA_{sw}), or the simultaneous mode of low band carrier aggregation (LBCA), or low band carrier aggregation switched mode (LBCA_{sw}) and the simultaneous mode of low band carrier aggregation (LBCA).

28. The apparatus as claimed in claim 26, where
the attributes of a first band combination are inherited or overwritten by the attributes of a second band combination wherein the first band combination is a subset of the second band combination.

29. A method, comprising:
receiving carrier aggregation capability information of a user equipment for at least one of: a transmission-to-reception switched operation or a reception-to-reception switched operation; and
transmitting configuration information for the carrier aggregation to the user equipment.

30. A non-transitory computer readable medium comprising program instructions that, when executed by an apparatus, cause the apparatus to perform:
receiving carrier aggregation capability information of a user equipment for at least one of: a transmission-to-reception switched operation or a reception-to-reception switched operation; and
transmitting configuration information for the carrier aggregation to the user equipment.
